(19) United States
(12) Patent Application Publication
(10) Pub. No.: US 2005/0096992 A1
(43) Pub. Date: May 5, 2005

(54) Image-enabled item processing for point of presentment application

(76) Inventors: Brian R. Geisel, Alpharetta, GA (US); Amar K. Verma, Alpharetta, GA (US); William A. Randlett, Canton, GA (US); Kavil S. Subramanian, Alpharetta, GA (US); Jeffrey T. Chinander, Norcross, GA (US); Ranjee B. Gangadhar, Alpharetta, GA (US)

Correspondence Address: HARNESS, DICKEY & PIERCE, P.L.C., P.O. BOX 828, BLOOMFIELD HILLS, MI, 48303, US

(21) Appl. No.: 10/698,710

(22) Filed: Oct. 31, 2003

(51) Int. Cl. G06F 17/60

(52) U.S. Cl. 705/24; 705/39

(57) ABSTRACT

A financial transaction processing system for use at a point of presentment includes an input receptive of an image of a physical item at least partially embodying a financial transaction, wherein the image contains a visual record of an amount of monetary value. An image recognition module is adapted to extract the amount of monetary value recorded in the image and recognize the amount using character recognition. A validation module is adapted to determine whether the transaction is valid based on a validation characteristic of an item. A balancing module is adapted to determine whether the transaction is balanced based on the amount of monetary value. An output is adapted to transmit information indicating whether the transaction is at least one of balanced and valid.

### FIELD OF THE INVENTION

The present invention generally relates to financial transaction systems, methods, and devices, and particularly relates to systems and methods of transaction automation at a point of presentment utilizing image recognition.

### BACKGROUND OF THE INVENTION

Financial institutions typically interact with parties to transactions, such as individuals, partnerships, companies, and corporations, by providing points of presentment at locations that are convenient to the parties to the transactions. Points of presentment include, for example, front counters of bank branches, cash vaults, merchant back offices, and automatic teller machines (ATMs) providing deposit automation. Parties to transactions typically present physical items embodying a transaction at these points of presentment, and these items typically include checks, cash, withdrawal slips, deposit slips, loan payment slips, and/or remittance slips.

While tellers often assist parties to transactions at some points of presentment, these tellers are typically required to spend excessive amounts of time and attention merely ensuring that a transaction is in balance. Furthermore, the tellers typically have no way of ensuring that all items of a transaction are valid. In addition, points of presentment affording no teller assistance rely entirely on the party to the transaction to ensure that the transaction is balanced. Moreover, financial institution branches typically assemble and process items long after the party to the transaction has departed the point of presentment. As a result, unbalanced and/or invalid transactions are discovered late, without affording the party to the transaction or teller at the point of presentment an opportunity to correct or otherwise balance the transaction.

The need remains, therefore, for a system and method of processing a transaction at a point of presentment that improves quality control of transactions while reducing time and labor requirements at a point of presentment. The present invention fulfills this need.

### SUMMARY OF THE INVENTION

In accordance with the present invention, an image-enabled, financial transaction processing system for use at a point of presentment includes an input receptive of an image of a physical item at least partially embodying a financial transaction, wherein the image contains a visual record of an amount of monetary value. An image recognition module is adapted to extract the amount of monetary value recorded in the image and recognize the amount using character recognition. A validation module is adapted to determine whether the transaction is valid based on a validation characteristic of an item. A balancing module is adapted to determine whether the transaction is balanced based on the amount of monetary value. An output is adapted to transmit information indicating whether the transaction is at least one of balanced and valid.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an entity relationship diagram illustrating a financial transaction system implemented at a point of presentment according to the present invention;

FIG. 2 is a functional block diagram illustrating an image-enabled, financial transaction processing system for use at a point of presentment according to the present invention;

FIGS. 3 and 4 are flow diagrams illustrating an image-enabled item processing method for use in performing a financial transaction at a point of presentment in accordance with the present invention.

### DETAILED DESCRIPTION OF THE PREFERRED EMBODIMENTS

The following description of the preferred embodiment(s) is merely exemplary in nature and is in no way intended to limit the invention, its application, or uses.

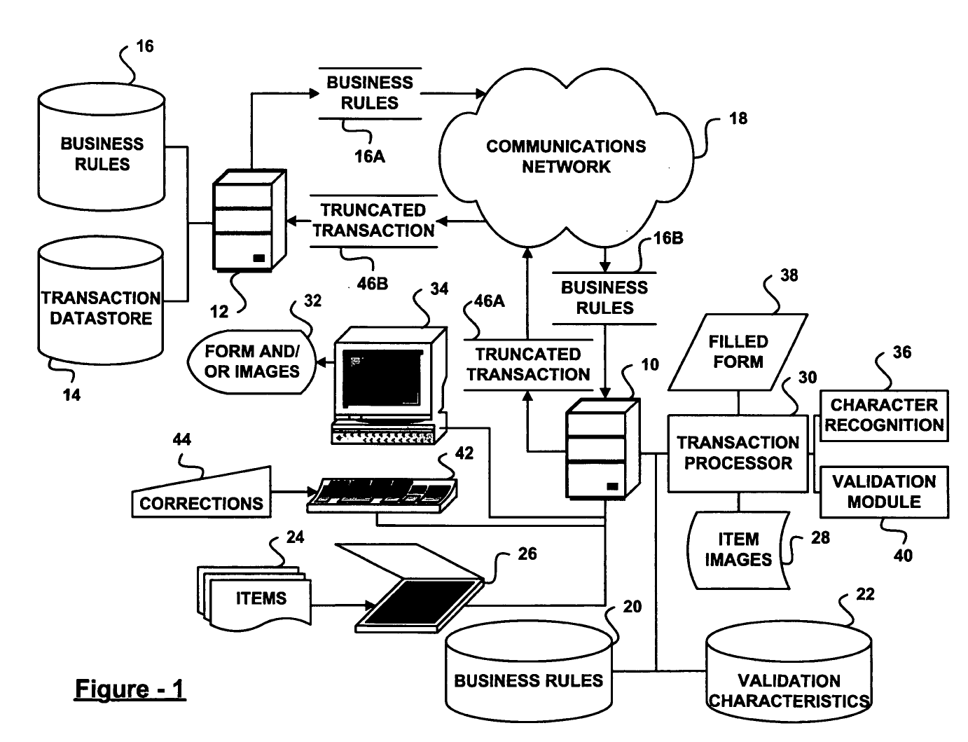

FIG. 1 illustrates a point of presentment 10 implementing the image-enabled, financial transaction processing system in accordance with the present invention. It is envisioned that a financial institution according to the present invention has a central location 12 with a relational transaction datastore 14 and centralized business rules 16. The central location 12 promulgates business rules 16 by daily transmitting business rules data 16A over a communications network 18, such as the Internet, to plural points of presentment 10. In turn, point of presentment 10 daily receives rules data 16B and stores it in rules datastore 20. Rules datastore 20 may include validation characteristics datastore 22, which stores validation characteristics for authenticating identity of parties and/or items. Validation characteristics may include routing numbers for financial institutions, account numbers for parties to transactions, one or more signatures or other biometric characteristics of individuals, and/or encryption keys, hash functions, and similar code features relating to digital watermarks, holograms, and other item features. As further explained below, business rules 16 of datastore 20 also define how to identify a type of document item based on image features and/or codeline data, how to extract, recognize, and utilize features from different types of documents, and how to validate and balance different types of transactions.

In a preferred embodiment, business rules 16 of datastore 22 include one or more electronic forms relating to different types of transactions, with methods for correlating item type locations with form fields and data type, and with a balancing function relating fields of the form. In operation, an operator at the point of presentment, such as a party to the transaction or teller assisting the party to the transaction, initiates a transaction by selecting an electronic form designated for performing the transaction. For example, if a teller selects to perform a deposit, then the teller takes the items 24, including a completed deposit slip, checks, and cash, from the party to the transaction at the point of presentment, and scans each of the checks and the deposit slip using imaging and scanning mechanism 26. It is envisioned that scanning mechanisms that read magnetic ink, image items, and sort items may be employed to validate and/or count a non-cash portion of the transaction. It is further envisioned that bill and/or coin acceptors, such as those employed with vending machines, may be employed with the present invention to validate and/or count a cash portion of the transaction. Such interface mechanisms may prove especially useful in implementations not affording teller assistance, such as with ATM deposit automation. It is yet further envisioned that a physical deposit slip may not be required in some embodiments of the present invention, and that an electronic form distributed to a user on a touch screen accepting a user signature, thumbprint, or other biometric, may serve as a substitute deposit slip.

Item images 28 are collected and stored together with recognized magnetic ink data, and each image is assigned a unique document identification number (DIN). Transaction processor 30 preferably identifies a type of item for each image based on magnetic ink codeline data associated with the image and in accordance with business rules 16 of datastore 20. It is envisioned that transaction processor 30 may also recognize types of items using image feature analysis. A poor image resulting, for example, from a folded corner results in display of the image on active display 32 of output 34 with a request that the image be rescanned. It is envisioned that other image quality control measures may also be employed. Transaction processor 30 performs feature extraction for item images 28 of sufficient quality and uses intelligent character recognition 32 to recognize the feature content for certain types of features. The recognized feature content, such as an amount of monetary value, is optionally combined with other feature content and inserted into a related field of electronic form 38. The field is related to the recognized feature content because it is associated with the particular extraction and recognition function employed to obtain the content from the item image. A balancing function of the form 38 compares a total of certain of the form fields to an extracted total to determined if they match. The filled form 38 is displayed on active display 32 with a message indicating whether the transaction is balanced.

Transaction processor 30 also employs validation module 40 to validate each item 24. For example, magnetic ink codeline data extracted from an item corresponding to a check may be used to compare a routing number of the codeline data to routing numbers of financial institutions stored in datastore 22. An account number from a check, deposit slip, or withdrawal slip can similarly be compared to an account number of a party to the transaction that is stored in datastore 22. Also, image features, such as signatures, icons, digital watermarks, and identifying text may be extracted, optionally recognized, and compared to similar types of data stored in datastore 22. For example, a signature can be aligned with a signature in memory to obtain a similarity metric useful for authenticating identity of a party to the transaction. If an item cannot be validated, a message indicating invalidity of the item is communicated to active display 32, and the item image and any recognized data are automatically removed from the transaction. This removal may throw the transaction out of balance. Therefore, the items can be returned to the party to the transaction at the point of presentment for correction immediately.

The teller may count the cash portion of the transaction and enter the cash portion into the electronic form via input 42. A substitute cash ticket image is created based on the cash amount, and the substitute cash ticket is added to images 28 of the transaction. The teller may also enter corrections 44 to replace field contents or add contents to empty fields in the case of failed recognition attempts. It is envisioned that the party to the transaction may enter these corrections in embodiments where teller assistance is not available. Once a validated transaction is in balance, the operator has the option of posting the transaction by communicating the transaction 46A and 46B to transaction datastore 14 of central location 12 via communications network 18. Accordingly, the item images 28 may be marked as truncated and communicated over network 18. It is also envisioned that filled form 38 may be bundled with one or more of the item images 22 in transaction 46A and 46B. As a result, the transaction can be reliably validated, balanced, and posted in a short amount of time in presence of the party to the transaction at the point of presentment. Meanwhile, the physical items 24 can be assembled and physically transported in turn, if necessary when truncation is not enabled.

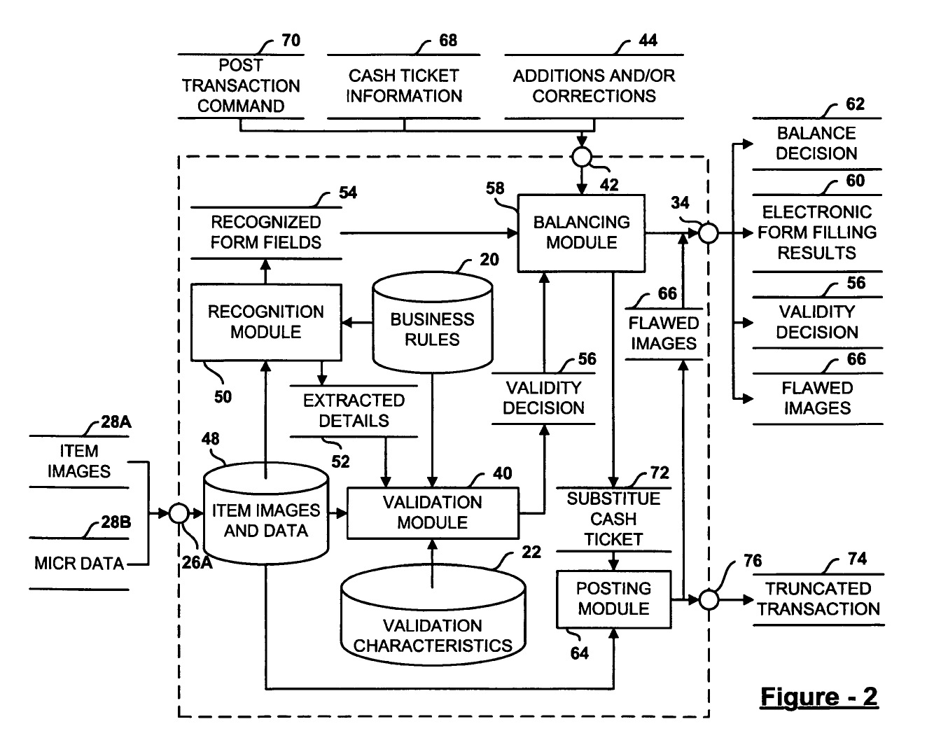

FIG. 2 illustrates function of transaction processor 30 in more detail. Data input 26A is receptive of electronic item images and magnetic ink codeline data 28A and 28B, which are stored in datastore 48. Recognition module 50 performs feature analysis, extracts image details 52, and recognizes image content for form fields 54 according to business rules of datastore 20. Validation module 40 compares codeline data and/or extracted details to validation characteristics of datastore 22 according to business rules of datastore 20. It is envisioned that extracted details may further be recognized as form fields 54, and codeline contents may be compared to corresponding recognized form fields as part of the validation process. Recognized form fields 54 and a validity decision 56 for each item are communicated to balancing module 58, which communicates form filling results 60, a balance decision 62, and/or one or more validity decisions 56 to an operator via output 34. It is envisioned that the identity of the operator may vary according to the accommodations afforded by the point of presentment. However, communication is maintained with the party to the transaction at the point of presentment of the items throughout the correction and balancing process, whether directly or through a teller assisting the party to the transaction.

Posting module 64 evaluates each image of datastore 48, and determines whether an image is flawed. If so, a rescan request in the form of the flawed image 66 is communicated to the operator via output 34. In turn, the operator may input more item images 28A and/or magnetic codeline data 28B in response to a rescan request, to replace an item with a new and/or altered item, and/or to add items. Input 42 is receptive of operator input specifying additions and or corrections 44, cash ticket information 68, and/or a post transaction command 70. It is envisioned that cash ticket information may alternatively be tallied and provided by a system having a bill acceptor and/or coin acceptor. It is further envisioned that balancing module 58 may be responsive to other commands from an operator, including a command to delete an item, to add an item, and/or to replace an item. Also, balancing module 58 is adapted to create substitute cash ticket 72 based on information 68, and to communicate it to posting module 72 upon receipt of command 70. In response, posting module 64 assembles item images together with substitute cash tickets of the transaction, marks truncated images as truncated using metadata, and transmits the resulting transaction 74 via data output 76. Communication of the substitute cash ticket is only one way to trigger posting of the transaction according to the present invention. It is envisioned that an option to enter a post transaction command may be withheld from the operator until the transaction is in balance. It is further envisioned that transaction 74 may further include electronic form filling results 60.

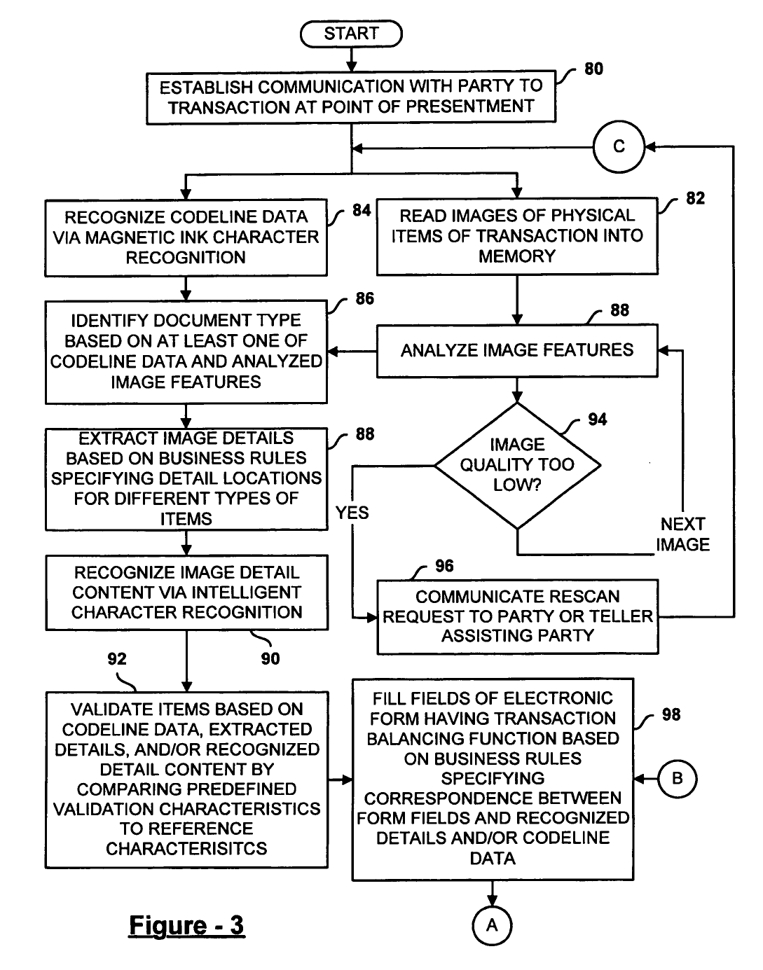

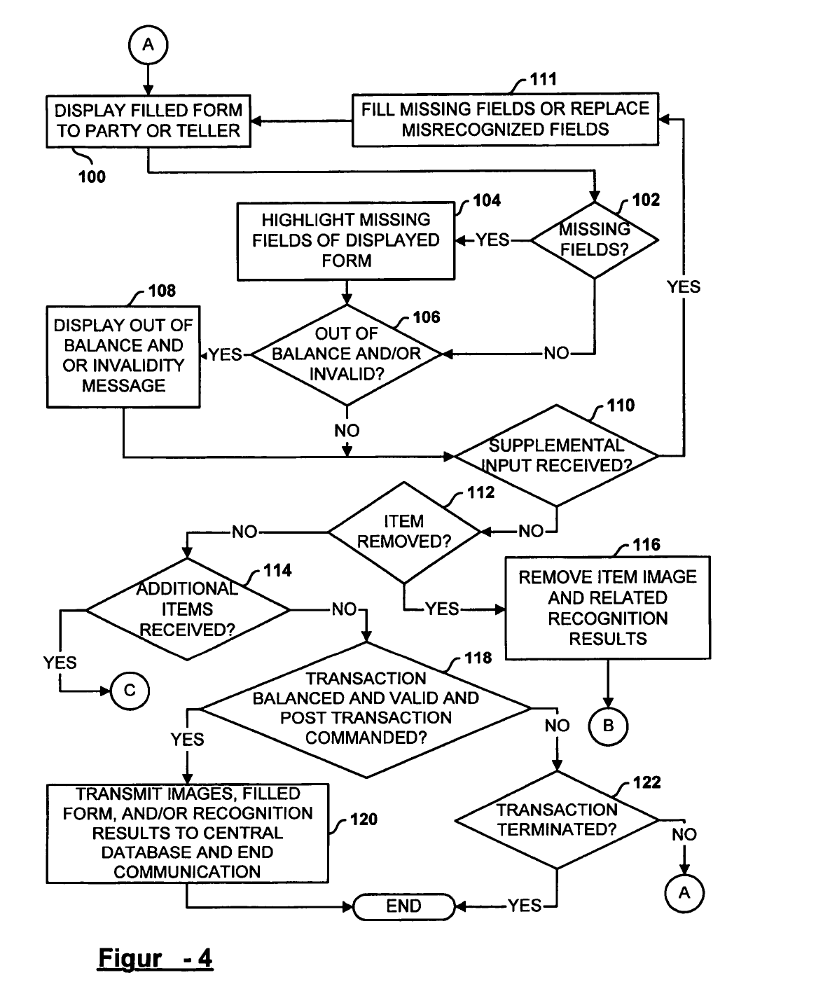

The preferred embodiment of the system of the present invention having now been described in detail, attention is now directed to the method according the present invention illustrated in FIGS. 3 and 4. FIG. 3 illustrates a first portion of an image-enabled item processing method for use in performing a financial transaction at a point of presentment in accordance with the present invention. Accordingly, at step 80, communication is established with a party to the transaction presenting physical items embodying the transaction at the point of presentment. The operator scans the items, preferably with an imaging mechanism having an ability to read magnetic ink. The result is simultaneous reading of item images and magnetic codeline data into computer memory at steps 82 and 84. The reading of codeline data is accomplished via magnetic ink character recognition at step 82. Each item image is assigned a unique document identification number (DIN) at step 82, and codeline data from step 84 is preferably stored together with the image.

At step 86, a document type is identified for each image based on recognized contents of the codeline from step 84, and recognition of document type may alternatively or additionally be based on image feature analysis results from step 88. Identification of a document such as a deposit slip, withdrawal slip, mortgage payment slip, or remittance slip may be employed to identify the type of transaction, or to notify an operator that a selected type of transaction may be incorrect. A record of the document type is preferably stored in memory with the image, and the DIN may be based in part on the document type.

At step 88, image details are extracted from each image based on document type and based on business rules specifying locations of details in the corresponding type of image. Details are recognized as appropriate to a type of the detail using intelligent character recognition at step 90. Image analysis techniques may facilitate these processes by identifying image details as nodes related to one another based on document location. Accordingly, a node may have a size and shape according to the results of document segmentation. Pattern recognition can further identify nodes as containing different types of content, such as graph versus text and letters versus numbers. Recognition attempts may substitute or confirm pattern recognition. Codeline contents and/or party identity may be matched to contents of one or more nodes to assist in identifying node type for each node in a process of elimination. Business rules may specify which types of image details should be recognized and how image detail contents should be utilized. Monetary amounts, party identities, financial institution identities, account numbers, routing numbers, addresses, and signatures can therefore be reliably extracted from checks, deposit slips, withdrawal slips, mortgage payment slips, and remittance slips and utilized as detailed below.

Extracted and recognized image details are utilized in various ways. For example, items may be validated based on codeline data, extracted details, and/or recognized detail contents by comparing these predefined validation characteristics to a plurality of validation characteristics stored in memory. Thus routing numbers may be matched to financial institutions, account numbers, extracted and recognized names and addresses, and signatures may be matched to parties to transactions. Also, security icons, such as holograms, and digital watermarks may be validated according to their predefined validation requirements. It is envisioned that input from holographic laser scanning devices and magnetic strip readers may additionally or alternatively be employed as part of the validation process. It is also envisioned that an operator, such as a teller, may be prompted to visually inspect scan with a special device a particular item having special validity characteristics, such as a hologram or a background that is designed to be difficult to scan or copy.

Extracted details, recognized detail contents, and/or codeline data may be compared to one another as part of the validation process. For example, an account number of codeline data may be compared to an extracted and recognized account number of the codeline data, and the party identity associated in computer memory with the account number may be compared to an extracted and recognized party identity. Also, an endorsement signature imaged on a revere side of the item can be matched by a similarity alignment to a signature or signature model stored in memory for the party identity. Further, a monetary amount extracted and recognized from one field of a check may be compared to a monetary amount extracted from another field of the check. As a result, the validation process ensures that items of the transaction are complete, correct, and authentic.

During the initial scanning process, image quality is maintained by image analysis techniques that identify a poorly scanned image as at 94. For example, a folded corner may be detected, resulting in communication of a rescan request to the operator at step 96. The previously scanned image is thus discarded and replaced with the new image of sufficient quality. This folded corner may be detected by an overall contrast of the image and/or by failure of an attempt to read the magnetic codeline. A failure of an attempt to read the codeline data can also detect improper insertion of the item, such as upside down or backwards insertion. Failure to identify a document type may also result in a rescan request at step 96. As a result, quality images are obtained and stored in association with reliably extracted image details and/or recognized detail content, with a document map and/or other metadata identifying document, detail, and/or content type in an appropriate business context. Advantageously, this useful data is obtained in a short period of time with relatively little effort on the part of an operator.

Recognized detail contents are utilized to fill fields of an electronic form for the type of transaction at step 98 as detailed above. This process is defined by business rules specifying correspondence between form fields and recognized contents and/or codeline data. Turning to FIG. 4, the filled form is displayed to the operator at step 100, and any missing fields as at 102 are highlighted on the active display at step 104. Also, if a balancing function of the form cannot match extracted totals to arithmetic combinations of related form fields, or if the transaction is invalid as at 106, then an appropriate invalidity and/or out of balance message is displayed to the operator at step 108. For example, a check total, a cash total, a cash back total, and an overall total extracted and recognized from a deposit slip may be appropriately matched against one another, against amounts extracted and recognized from checks, and against specific enumerations of check amounts extracted and recognized from the deposit slip. An operator has the option to supply supplemental input with a keyboard, mouse, touchscreen, microphone with speech recognition capability, and/or other input mechanism as at 110, to remove an item as at 112, or to add an item as at 114. Receipt of supplemental input at 110 may result in filling in of missing fields and/or correction of misrecognized fields at step 111. Removal of an item may result in removal of the item image and related recognition results at step 116 and return to step 98 (FIG. 3). An invalid transaction can be made valid by removal and/or replacement of the invalid items. It is envisioned that an image of an invalid item may be retained for inspection by authorities or other personnel. Replacement of an item may be accomplished by recursive removal of the item at 116 (FIG. 4), and subsequent addition of an item at 114, which returns processing to steps 82 (FIG. 3) and 84.

If the transaction is valid and balanced as at 118 (FIG. 4), then the operator has the option to post the transaction, thus confirming the form fields. Form fields thus confirmed may include extracted and recognized cash amounts and/or cash amounts entered by hand or supplied by a bill and/or coin acceptor. As a result, the operator provides any needed cash ticket data, so that a substitute cash ticket image may be created and added to the transaction. Thus, the transaction images and related data may be transmitted at step 120, and truncated images may be marked as such with metadata. The option to truncate an image may be specified and enforced by business rules, and sorting, collecting, and processing of the physical items may be automated accordingly. However, if the transaction is invalid or out of balance, then the operator must select one of the aforementioned options other than posting the transaction or else must terminate the transaction as at 122.

The description of the invention is merely exemplary in nature and, thus, variations that do not depart from the gist of the invention are intended to be within the scope of the invention. For example, a corporate center or other point of presentment may have the ability to scan images, but the scanned images may be communicated to a remote center that performs one or more of the processes of the present invention and communicates results back to the point of presentment. Thus, validation may take place remotely in one case to ensure security of validation characteristics. This functionality prevents distribution of a financial institutions account numbers, code keys, and other sensitive data to a corporate client. Remote recognition and correction procedures may be similarly supported.

Also, it is envisioned that an ATM according to the present invention may have a bill acceptor and allow a party to validate a deposit by inserting an ATM card and entering a PIN number. Then the user may deposit cash to a specified account associated with the ATM card by inserting cash via the bill acceptor. The amount of funds to be deposited are then communicated to the party by an active display of the ATM, and the party has an opportunity to immediately post or terminate the deposit. In the case of a termination, the accepted cash is returned to the user.

It is further envisioned that an ATM machine may have check scanning, imaging, and sorting capability, and will allow the party to insert endorsed checks of a deposit. An electronic form substituting for a deposit slip may be displayed to the user, and the party may select cash back and electronically sign the form via touch screen capability. Signature recognition may be used on the endorsements of the checks and/or touchscreen captured signature to authenticate identities of parties to transactions. Also, facial recognition, thumbprint recognition, retina scans, and other uses of biometrics may further be implemented to authenticate the party identity. Further, checks may be validated as detailed above. These checks may be marked paid and collected by the ATM. Such variations are not to be regarded as a departure from the spirit and scope of the invention.

1. An image-enabled, financial transaction processing system for use at a point of presentment, comprising:
an input receptive of an image of a physical item at least partially embodying a financial transaction, wherein the image contains a visual record of an amount of monetary value;
an image recognition module adapted to extract the amount of monetary value recorded in the image and recognize the amount using character recognition;
a validation module adapted to determine whether the transaction is valid based on a validation characteristic of an item;
a balancing module adapted to determine whether the transaction is balanced based on the amount of monetary value; and
an output adapted to transmit information indicating whether the transaction is at least one of balanced and valid.

2. The system of claim 1, wherein said input is receptive of information in a non-image format that includes said validation characteristic.

3. The system of claim 1, wherein the validation characteristic is visually recorded in the image, and said image recognition module is adapted to extract the validation characteristic recorded in the image.

4. The system of claim 3, wherein the validation characteristic corresponds to at least one of a routing number and an account number, and said image recognition module is adapted to recognize the validation characteristic using character recognition.

5. The system of claim 3, wherein the validation characteristic corresponds to a signature of a party to the transaction, the system further comprising a biometric analysis module adapted to perform a similarity alignment between the signature and a signature stored in memory.

6. The system of claim 3, wherein the validation characteristic corresponds to a digital watermark.

7. The system of claim 1, wherein said input is further receptive of an electronic substitute cash ticket having an amount of monetary value associated therewith, and said balancing module is further adapted to determine whether the transaction is balanced based on the amount of monetary value associated with the substitute cash ticket.

8. The system of claim 1, wherein said input is receptive of multiple images of multiple physical items embodying the transaction, wherein one image is of an item representative of the transaction as a whole, and said balancing module is adapted to compare totals of amounts extracted from image of items to totals of amounts visually recorded in the image of the item representative of the transaction as a whole.

9. The system of claim 1, wherein said balancing module is adapted to generate an electronic version of the transaction, said output is adapted to transmit the electronic version, said input is receptive of supplemental information assistive in at least one of balancing and validating the transaction, and said balancing module is adapted to balance the transaction based on the supplemental information.

10. The system of claim 1, wherein said output is adapted to transmit an electronic version of the transaction including the images.

11. The system of claim 10, wherein the electronic version of the transaction includes metadata marking the transaction as a truncated transaction.

12. An image-enabled item processing method for use in performing a financial transaction at a point of presentment, comprising:
initiating communication with a party to a transaction at a point of presentment of physical items embodying the transaction, wherein at least one physical item has an amount of monetary value visually recorded thereon;
reading item images into computer memory by generating an image record of each of the physical items and storing the image records in computer memory;
validating the transaction by comparing a validation characteristic of at least one item to a validation characteristic stored in computer memory;
recognizing at least one amount of monetary value recorded on the items by extracting amounts from the item images and recognizing extracted amounts;
balancing the transaction based on at least one recognized amount before terminating communication with the customer at the point of presentment; and
posting the transaction, including transmitting the item images to a central location having a relational database storing records of transactions.

13. The method of claim 12, further comprising correcting the transaction before said balancing the transaction.

14. The method of claim 13, wherein said step of correcting the transaction includes correcting misrecognition of an item detail stored computer memory.

15. The method of claim 13, wherein step of correcting the transaction includes:
communicating a need for alteration of an item to the party to the transaction;
reading an altered item image into computer memory; and
reflecting alteration of the item in the transaction.

16. The method of claim 13, wherein said step of correcting the transaction includes:
communicating need for removal of an item to the party to the transaction; and
removing the item from the transaction.

17. The method of claim 13, wherein said step of correcting the transaction includes:
requesting at least one additional item from the party to the transaction;
reading an additional item image into computer; and
adding the additional item image to an electronic version of the transaction.

18. The method of claim 13, wherein said step of correcting the transaction includes:
communicating invalidity of an item to the party to the transaction at the point of presentment; and
removing the invalid item from the transaction.

19. The method of claim 13, wherein said step of correcting the transaction include:
reading an item image into computer memory a second time; and
replacing a first instance of the item image in computer memory with a second instance of the item image.

20. The method of claim 12, further comprising:
creating a substitute cash ticket image; and
adding the substitute cash ticket image to an electronic version of the transaction.

21. The method of claim 12, further comprising tagging an item image with metadata identifying the item image as truncated.

22. The method of claim 12, further comprising employing centralized business rules specifying validation and recognition procedures that are promulgated by a user from a central location to remote locations affording points of presentment.

23. The method of claim 12, wherein said step of validating the transaction includes comparing a code line of an item to a plurality of code lines of financial institutions prior to said balancing the transaction.

24. The method of claim 12, wherein said step of validating the transaction includes:
identifying a party to the transaction associated with a selected one of the physical items;
extracting a signature of the party to the transaction from an item image related to the selected one of the physical items; and
comparing the signature extracted from the item image to a signature of the party to the transaction stored in computer memory.

25. The method of claim 12, further comprising:
attempting to recognize a party to the transaction identity and a total transaction amount based on an image of a deposit slip of the transaction;
attempting to recognize check amounts based on images of checks of the transaction, wherein at least one attempt is governed at least in part by a code line of an associated check;
partially filling an electronic form representing the transaction based on successful recognition attempts; and
completely filling the electronic form based on input from at least one of the party to the transaction and a teller at the point of presentment in communication with the party to the transaction.

26. The method of claim 25, further comprising prompting at least one of the party to the transaction and the teller at the point of presentment for input in the case of a failed recognition attempt.

27. The method of claim 25, further comprising:
making a comparison between a total amount of the electronic form and a summation of transaction item amounts present in the electronic form; and
informing at least one of the party to the transaction and the teller at the point of presentment of results of the comparison.

28. The method of claim 25, wherein said step of posting the transaction includes storing the item images in computer memory in association with the electronic form.
